(19) United States
(12) Patent Application Publication
(10) Pub. No.: US 2025/0178523 A1
(43) Pub. Date: Jun. 5, 2025

(54) TURN AND BRAKE INDICATOR FOR A VEHICLE

(71) Applicant: Jeffrey Brown, Lafayette, IN (US)

(72) Inventor: Jeffrey Brown, Lafayette, IN (US)

(21) Appl. No.: 18/526,550

(22) Filed: Dec. 1, 2023

(51) Int. Cl. B60Q 1/44; B60Q 1/38

(52) U.S. Cl. CPC B60Q 1/442; B60Q 1/38

(57) ABSTRACT

A vehicle for indicating to viewers in front of the vehicle when the vehicle is decelerating and about to make a turn includes a brake deployment indicator. The brake employment indicator is mounted to a front end of a body of the vehicle and activates when a brake pedal and a turn signal are both operated. The brake deployment indicator may include a light which is visually distinct from rear brake lights of the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to brake lights and more particularly pertains to a new brake light for indicating to viewers in front of a vehicle that the vehicle is decelerating and about to make a turn.

### (2) Description of Related Art Including Information Disclosed Under 37 CFR 1.97 and 1.98

The prior art describes various brake lights which are mounted to a front end of a vehicle to indicate to viewers in front of the vehicle that the vehicle is decelerating. However, the prior art fails to disclose such an apparatus which signals to such viewers that the vehicle is decelerating only if a turn signal is displayed. Such an apparatus would inform the viewers that the vehicle is not decelerating when the brake light does not activate, so the viewers know it would not be safe to move into an area in front of the vehicle.

### BRIEF SUMMARY OF THE INVENTION

An embodiment of the disclosure meets the needs presented above by generally comprising a body defining a cabin therein and a plurality of wheels rotatably coupled to the body. A brake pedal is mounted in the cabin of the body and is operatively coupled to the plurality of wheels to arrest rotation of the plurality of wheels with respect to the body. A turn indicator is mounted to a front end of the body and is configured to present a turn signal when the turn indicator is activated. A brake deployment indicator is mounted to the front end of the body and is configured to present a brake deployment signal in response to the turn indicator is activated and the brake pedal is operated to arrest rotation of the plurality of wheels.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a vehicle according to an embodiment of the disclosure.

FIG. 2 is a side view of an embodiment of the disclosure.

FIG. 3 is a block diagram of an embodiment of the disclosure.

### DETAILED DESCRIPTION OF THE INVENTION

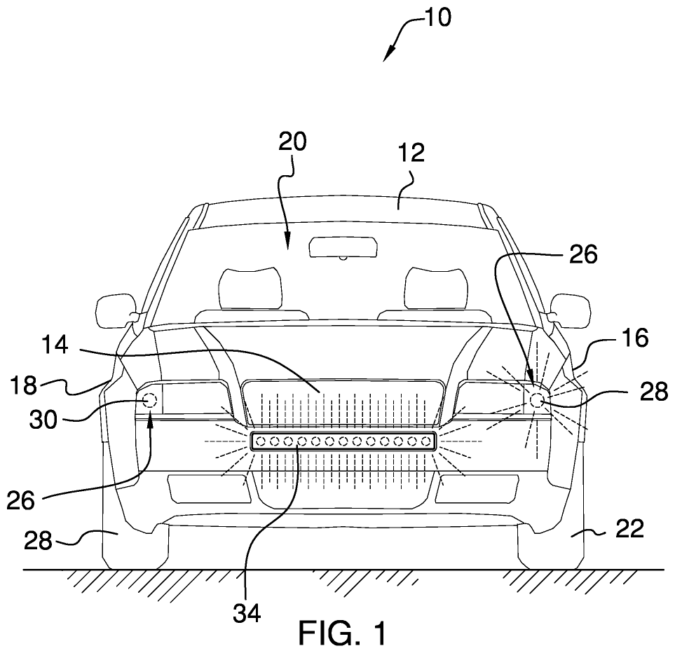

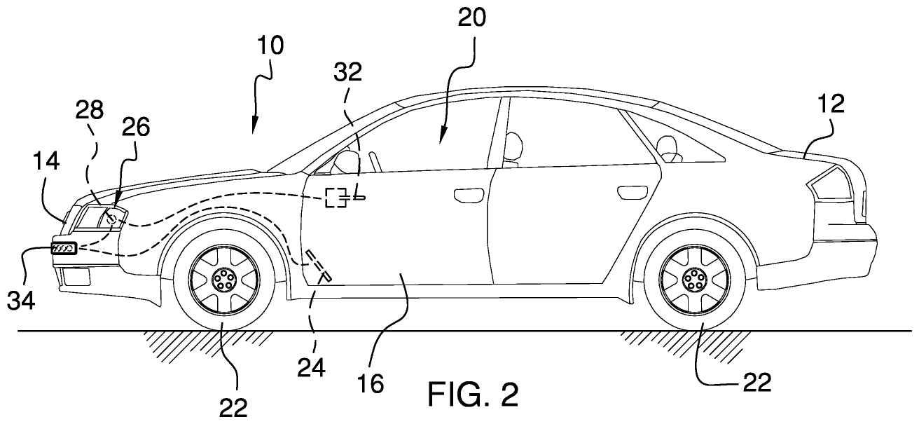

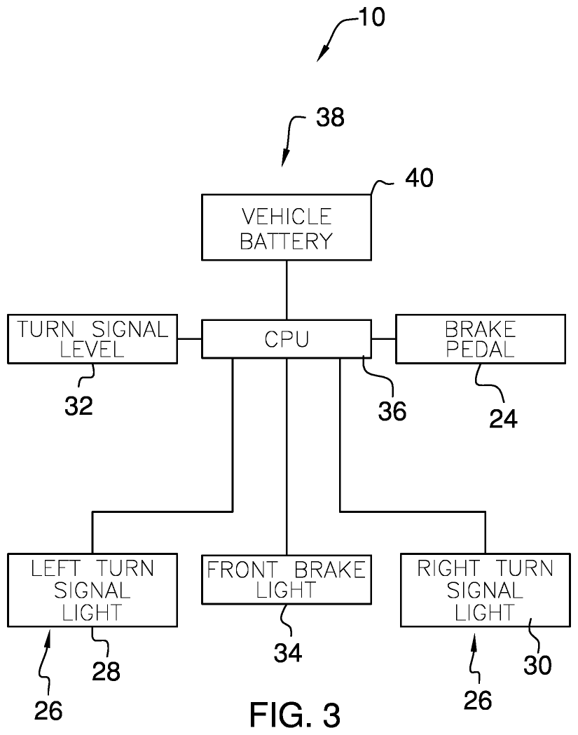

With reference now to the drawings, and in particular to FIGS. 1 through 3 thereof, a new vehicle embodying the principles and concepts of an embodiment of the disclosure and generally designated by the reference numeral 10 will be described.

As best illustrated in FIGS. 1 through 3, the vehicle 10 generally comprises a body 12 defining a cabin 20 therein and a plurality of wheels 22 rotatably coupled to the body 12. A brake pedal 24 is mounted in the cabin 20 of the body 12 and is operatively coupled to the plurality of wheels 22 to arrest rotation of the plurality of wheels 22 with respect to the body 12. The brake pedal 24 in some embodiments may be operatively coupled to less than all of the plurality of wheels 22 but is generally contemplated to be actuatable to arrest motion of the vehicle 10. A pair of turn indicators 26 is mounted to a front end 14 of the body 12. Each turn indicator 26 of the pair of turn indicators 26 is configured to present a turn signal when the turn indicator 26 is activated. The pair of turn indicators 26 includes a left turn indicator 28 positioned adjacent to a left side 16 of the body 12 and a right turn indicator 30 positioned adjacent to a right side 18 of the body 12. Each turn indicator 26 includes a turn light source but may present the turn signal via any suitable visual indication. A turn indicator actuator 32 is mounted in the cabin 20 and is operatively coupled to the pair of turn indicators 26. Each turn indicator 26 of the pair of turn indicators 26 is selectively activatable via the turn indicator actuator 32.

A brake deployment indicator 34 is mounted to the front end 14 of the body 12 and is configured to present a brake deployment signal in response to one of the pair of turn indicators 26 being activated and the brake pedal 24 is operated to arrest rotation of the plurality of wheels 22. The brake deployment indicator 34 includes a brake light source which is configured to emit light visually distinct from rear brake lights of the vehicle 10. The brake deployment light source may emit light in a color other than red, such as blue or green. The brake deployment light source also may emit light in a strobing pattern or be otherwise visually distinct from the rear brake lights of the vehicle 10. The brake deployment indicator 34 is positioned between the pair of turn indicators 26. In some embodiments, the brake indicator may extend across the front end 14 of the body 12 from the left side 16 of the body 12 to the right side 18. In other embodiments, the brake indicator may include a pair of indicator members, each of which is positioned adjacent to an associated one of the pair of turn indicators 26. In such cases, the indicator members may be activated individually in response to operation of the brake pedal 24 and the adjacent turn indicator 26, or the indicator members may both be activated simultaneously in response to the operation of the brake pedal 24 and either turn indicator 26.

A processor 36 is communicatively coupled, wirelessly or via a wired connection, to the brake pedal 24 and the turn indicator actuator 32. The processor 36 is also operatively coupled, wirelessly or via a wired connection, to the pair of turn indicators 26 and the brake deployment indicator 34. The processor 36 is configured to cause a selected one of the pair of turn indicators 26 to activate in response to a corresponding actuation of the turn indicator actuator 32 and to cause the brake deployment indicator 34 to present the brake deployment signal in response to one of the pair of turn indicators 26 being activated and the brake pedal 24 being operated. A power source 38 is electrically coupled to the processor 36. The power source 38 comprises a battery 40 but may comprise a capacitor or suitable other power storage. The power source 38 may also power the pair of turn indicators 26, the brake deployment indicator 34, and other electrical components in the vehicle 10.

In use, the brake deployment indicator 34 presents the brake deployment signal when the brake pedal 24 and one of the turn indicators 26 are operated. Viewers for which the front end 14 of the vehicle 10 is visible will then be able to perceive that the vehicle 10 is decelerating in preparation for a turn operation, a lane merge operation, or the like. When the viewers only see the turn signal of one of the turn indicators 26 and not the brake deployment signal, the viewer will be able to perceive that the vehicle 10 is not decelerating in preparation for any such operation and it would be unsafe to move into a space in front of the vehicle 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle comprising:
a body defining a cabin therein;
a plurality of wheels rotatably coupled to the body;
a brake pedal mounted in the cabin of the body, the brake pedal being operatively coupled to the plurality of wheels to arrest rotation of the plurality of wheels with respect to the body;
a turn indicator mounted to a front end of the body, the turn indicator being configured to present a turn signal when the turn indicator is activated;
a brake deployment indicator mounted to the front end of the body, the brake deployment indicator being configured to present a brake deployment signal in response to the turn indicator being activated and the brake pedal being operated to arrest rotation of the plurality of wheels.

2. The vehicle of claim 1, wherein the turn indicator is one of a pair of turn indicators mounted to a front end of the body, each turn indicator of the pair of turn indicators being configured to present a turn signal when the turn indicator is activated, the brake deployment indicator being configured to present the brake deployment signal in response to one of the pair of turn indicators being activated and the brake pedal being operated to arrest rotation of the plurality of wheels.

3. The vehicle of claim 2, wherein the pair of turn indicators includes a left turn indicator and a right turn indicator, the left turn indicator being positioned adjacent to a left side of the body, the right turn indicator being positioned adjacent to a right side of the body.

4. The vehicle of claim 3, wherein the brake deployment indicator is positioned between the pair of turn indicators.

5. The vehicle of claim 2, wherein the brake deployment indicator includes a pair of indicator members, each indicator member of the pair of indicator members being positioned adjacent to an associated one of the pair of turn indicators.

6. The vehicle of claim 1, wherein the turn indictor includes a turn light source.

7. The vehicle of claim 1, wherein the brake deployment indicator includes a brake light source.

8. The vehicle of claim 7, wherein the brake light source is configured to emit light in a color other than red.

9. The vehicle of claim 7, wherein the brake light source strobes.

10. The vehicle of claim 1, further comprising a turn indicator actuator mounted in the cabin and operatively coupled to the turn indicator, the turn indicator being selectively activatable via the turn indicator actuator.

11. The vehicle of claim 10, further comprising a processor communicatively coupled to the brake pedal and the turn indicator actuator, the processor being operatively coupled to the turn indicator and the brake deployment indicator, the processor being configured to cause the brake deployment indicator to present the brake deployment signal in response to one of the pair of turn indicators being activated and the brake pedal being operated.

12. The vehicle of claim 11, wherein the processor is configured to cause a selected one of the pair of turn indicators to activate in response to a corresponding actuation of the turn indicator actuator.

13. The vehicle of claim 11, further comprising a power source being electrically coupled to the processor, the power source comprising a battery.

14. A vehicle comprising:
a body defining a cabin therein;
a plurality of wheels rotatably coupled to the body;
a brake pedal mounted in the cabin of the body, the brake pedal being operatively coupled to the plurality of wheels to arrest rotation of the plurality of wheels with respect to the body;
a pair of turn indicators mounted to a front end of the body, each turn indicator of the pair of turn indicators being configured to present a turn signal when the turn indicator is activated, each turn indicator of the pair of turn indicators including a turn light source, the pair of turn indicators including a left turn indicator and a right turn indicator, the left turn indicator being positioned adjacent to a left side of the body, the right turn indicator being positioned adjacent to a right side of the body;
a brake deployment indicator mounted to the front end of the body, the brake deployment indicator being configured to present a brake deployment signal in response to one of the pair of turn indicators being activated and the brake pedal being operated to arrest rotation of the plurality of wheels, the brake deployment indicator including a brake light source, the brake light source being configured to emit light in a color other than red, the brake deployment indicator being positioned between the pair of turn indicators;
a turn indicator actuator mounted in the cabin and operatively coupled to the pair of turn indicators, each turn indicator of the pair of turn indicators being selectively activatable via the turn indicator actuator;
a processor communicatively coupled to the brake pedal and the turn indicator actuator, the processor being operatively coupled to the pair of turn indicators and the brake deployment indicator, the processor being configured to cause a selected one of the pair of turn indicators to activate in response to a corresponding actuation of the turn indicator actuator, the processor being configured to cause the brake deployment indicator to present the brake deployment signal in response to one of the pair of turn indicators being activated and the brake pedal being operated; and
a power source being electrically coupled to the processor, the power source comprising a battery.
